(19) United States
(12) Patent Application Publication
(10) Pub. No.: US 2011/0273557 A1
(43) Pub. Date: Nov. 10, 2011

(54) POSITION MEASURING SYSTEM

(75) Inventors: Yasushi Ichizawa, Tokyo (JP); Minoru Akutsu, Tokyo (JP); Naomichi Chida, Tokyo (JP)

(73) Assignee: YOKOGAWA ELECTRIC CORPORATION, Tokyo (JP)

(21) Appl. No.: 13/100,658

(22) Filed: May 4, 2011

(30) Foreign Application Priority Data
May 7, 2010 (JP) 2010-107130

(51) Int. Cl. H04N 7/18

(52) U.S. Cl. 348/88; 348/E07.085

(57) ABSTRACT

In a position measuring system for measuring a position of a preset target portion of a conveyed sheet-like material with a camera, the system comprises a first camera unit installed substantially above one edge of the sheet-like material, including an image pickup device to receive a focused image of the sheet-like material, and taking an image of the target portion of the sheet-like material, a second camera unit installed substantially above the other edge of the sheet-like material, including an image pickup device to receive a focused image of the sheet-like material, and taking an image of the target portion of the sheet-like material, and a measuring unit for, based on variations of positions of the target portion from preset reference positions in the images of the sheet-like material focused on the respective image pickup devices, determining occurrence of a pass line fluctuation that displaces the sheet-like material in a vertical direction, and measuring a position deviation of the target portion.

### CROSS-REFERENCE TO RELATED APPLICATIONS

This application is based upon and claims the benefit of priority from the prior Japanese Patent Application No. 2010-107130, filed on May 7, 2010, the entire content of which is incorporated herein by reference.

### BACKGROUND

1. Field

A position measuring system, which is used to produce (form or coat) a uniform sheet-like material by accurately controlling the installed position of a thickness measuring device, and which measures the position of one or more preset portions (e.g., positions of both edges) of a conveyed sheet-like material by using cameras. More particularly, a position measuring system for, in a production line in which the position of a preset target portion (e.g., a coating end (edge)) of a sheet-like material is to be measured, accurately measuring a position deviation of the preset target portion (e.g., the edge) without being affected by a coating pattern that is changed depending on the product type.

2. Related Art

Hitherto, there is known a position measuring system for measuring an edge position of a sheet-like material, determining a “deviation” between the measured edge position and a reference position, and calculating an amount and a direction of movement that is required to compensate for the “deviation” and to arrange the sheet-like material in an appropriate position.

Such a position measuring system is used to produce (form or coat) a uniform sheet-like material by accurately controlling the installed position of a thickness measuring device.

FIG. 3 illustrates one example of configuration of the known position measuring system.

Referring to FIG. 3, the known position measuring system includes feed rollers (not shown) for supporting and conveying battery electrode sheets 100 and 101, which are one example of the sheet-like material, cameras 1a to 1e for taking images of preset target portions and edges (ends) of the battery electrode sheets 100 and 101 through lenses 2a to 2e, respectively, and an arithmetic and control means, which is electrically connected to the cameras 1a to 1e, which measures, based on the positions of the target portions and the edges of the battery electrode sheets in the images taken by the cameras, deviations of the target portions and the edges from the positions of respective preset references (hereinafter referred to as the “reference positions”), and which transmits, to a driving means (not shown), control data for position control to compensate for the position deviations, thereby controlling the battery electrode sheets to be located in correct positions.

The battery electrode sheets 100 and 101 as one example of the sheet-like material are conveyed in such a state that the sheets are supported by the feed rollers (not shown) and a pass line of the conveyed sheets is held almost constant.

Those two rows of battery electrode sheets are successively arranged side by side in a direction crossing (perpendicular) to the lengthwise direction of the sheets (i.e., to the sheet feed direction).

The cameras 1a to 1e and the lenses 2a to 2e are combined with each other and are arranged substantially above the battery electrode sheets 100 and 101 in a direction substantially perpendicular (vertical) to the feed direction of the battery electrode sheets 100 and 101.

The shooting magnification and the shooting distance of each of the lenses 2a to 2e attached to the cameras 1a to 1e are determined depending on resolution and accuracy, which are required for measurement of the target portions and the edges.

In the above-described known position measuring system, there may occur a phenomenon (hereinafter referred to as a “pass line fluctuation”) that the battery electrode sheets 100 and 101 flutter up and down during the feed (conveyance).

Because the measurement accuracy demanded in a coating step to coat the uniform sheet-like material is on the order of about several tens microns, the positions of the edges and the target portions need to be accurately measured in order that the coating step is not affected by the pass line fluctuation.

For that reason, preferably, the cameras 1a to 1e take images of the edges (coating ends), etc. from right above them by using lenses each of which constitutes, for example, a telecentric optical system. It is, however, to be noted that such a telecentric optical system is not necessarily required when the camera is designed to take the image at a high magnification from a short distance.

In more detail, the camera 1a and the lens 2a are installed substantially above an outer peripheral end of one of the battery electrode sheets 100 and 101 that are successively arranged side by side (i.e., above an edge of the battery electrode sheet 100 on the side not adjacent to the battery electrode sheet 101).

The camera 1b and the lens 2b are installed substantially above a target portion of the one 100 of the battery electrode sheets 100 and 101 that are successively arranged side by side.

The camera 1c and the lens 2c are installed substantially above inner peripheral ends of the battery electrode sheets 100 and 101 that are successively arranged side by side (e.g., above an edge of each one of the battery electrode sheets 100 and 101 on the side adjacent to the other battery electrode sheet).

The camera 1d and the lens 2d are installed substantially above a target portion of the other one 101 of the battery electrode sheets 100 and 101 that are successively arranged side by side.

The camera 1e and the lens 2e are installed substantially above an outer peripheral end of the other of the battery electrode sheets 100 and 101 that are successively arranged side by side (i.e., above an edge of the battery electrode sheet 101 on the side not adjacent to the battery electrode sheet 100).

The cameras 1a to 1e are constituted as line cameras or area cameras and take the images of the edges and the target portions of the battery electrode sheets 100 and 101.

More specifically, the camera 1a takes, through the lens 2a, the image of the edge of the battery electrode sheet 100 (i.e., the edge of the battery electrode sheet 100 on the side not adjacent to the battery electrode sheet 101).

The camera 1b takes, through the lens 2b, the image of the target portion of the battery electrode sheet 100.

The camera 1c takes, through the lens 2c, the image of the edge of each one of the battery electrode sheets 100 and 101 on the side adjacent to the other battery electrode sheet (i.e., the edges of the battery electrode sheets 100 and 101 on the side adjacent to the battery electrode sheets 101 and 100).

The camera 1d takes, through the lens 2d, the image of the target portion of the battery electrode sheet 101.

The camera 1e takes, through the lens 2e, the image of the edge of the battery electrode sheet 101 (i.e., the edge of the battery electrode sheet 101 on the side not adjacent to the battery electrode sheet 100).

While FIG. 3 illustrates the case of two-row coating (i.e., the case where, for example, carbon is coated on a metal foil, serving as a base material, in two rows instead of full-surface coating), the coating manner is not always restricted to the two-row coating and may be changed to, e.g., three- or four-row coating depending on the product type.

In the known position measuring system, when the coating manner is changed to, e.g., the three- or four-row coating depending on the product type as mentioned above, the cameras are arranged to be located in a close relation substantially perpendicularly to the feed direction of the battery electrode sheets such that visual fields of the cameras are not disconnected and the system is adaptable regardless of wherever the coating ends of the battery electrode sheets are positioned.

The known position measuring system thus constructed operates as follows.

(1) The feed rollers convey the battery electrode sheets 100 and 101.

(2) The cameras 1a to 1e take the images of the preset target portions and the edges (ends) of the conveyed battery electrode sheets 100 and 101 through the lenses 2a to 2e, respectively, and transmit the taken image data to the arithmetic and control means (not shown).

(3) The arithmetic and control means measures position deviations from reference positions based on the taken image data (representing the positions of the target portions and the edges of the sheets) received from the cameras, and transmits control data, which is used for position control to compensate for the position deviations, to a driving means (not shown).

For example, when it is determined that the sheet end is deviated to the right from the normal position, the arithmetic and control means transmits the control data to the driving means so as to move the relevant sheet to the left.

(4) In accordance with the control data received, the driving means moves the positions of the battery electrode sheets 100 and 101. For example, the driving means moves the relevant sheet to the left in accordance with the control data.

Thus, in the known position measuring system, the plural cameras installed substantially above the target portions and the edges of the battery electrode sheets 100 and 101 measure the positions of the target portions and the edges, and the arithmetic and control means calculates deviations of the measured positions of the target portions and the edges from the reference positions and further calculates the amounts and the directions of movements that are required to compensate for the deviations. As a result, the battery electrode sheets can be controlled to be arranged at the correct positions.

Related-art technical documents regarding the above-described position measuring system are as follows. Japanese Unexamined Patent Application Publication No. 2003-068285. Japanese Unexamined Patent Application Publication No. 2007-285867.

Japanese Unexamined Patent Application Publication No. 2003-068285 discloses a method of detecting, e.g., coating ends of a sheet-like material with coating end sensors installed near the coating ends without using cameras.

Meanwhile, when the deviations of the positions of the target portions and the edges (e.g., the coating ends) are measured in the position measuring system to perform control such that the sheet-like material is arranged at the correct position, the measurement does not give any added value to products obtained with the production line. Therefore, the measurement is desirably carried out by using relatively inexpensive devices. From that point of view, various methods can be proposed because levels of detection accuracy and technical difficulty (complexity) required for the measurement of the position deviations of the target portions and the edges are not so high.

However, the known position measuring system has the problem that when the lens used in combination with the camera is expensive, the system cost is increased as the number of cameras increases, and cost efficiency is reduced.

Another problem is that because a set of the camera and the lens is installed above the position of each of the target portions and the edges, installation work takes a longer time as the number of cameras increases.

Further, the position measuring system disclosed in the above-cited Japanese Unexamined Patent Application Publication No. 2003-068285 has the problem that when the coating manner differs depending on the product type of the sheet-like material, the coating end sensors have to be reinstalled in appropriate positions near the coating ends, and set-up operation is required for the new installed positions. Such a case raises another problem that the production line has to be stopped during the set-up operation.

### SUMMARY

With the view of overcoming the problems described above, an object is to provide a position measuring system, which can accurately measure a position deviation of a target portion (e.g., an edge) without being affected by a coating pattern that is changed depending on the product type (namely, without needing set-up operation for each of different product types).

To achieve the above object, according to a first aspect of the present invention, for example, there is provided a position measuring system for measuring a position of a preset target portion of a conveyed sheet-like material with a camera, the position measuring system comprising first camera means installed substantially above one edge of the sheet-like material, including an image pickup device to receive a focused image of the sheet-like material, and taking an image of the target portion of the sheet-like material, second camera means installed substantially above the other edge of the sheet-like material, including an image pickup device to receive a focused image of the sheet-like material, and taking an image of the target portion of the sheet-like material, and measuring means for, based on variations of positions of the target portion from preset reference positions in the images of the sheet-like material focused on the respective image pickup devices, determining occurrence of a pass line fluctuation that displaces the sheet-like material in a vertical direction, and measuring a position deviation of the target portion.

According to a second aspect of the present invention, in the position measuring system according to the first aspect, for example, the system further comprises storage means for previously storing a first reference position and a second reference position as reference positions for the target portion of the sheet-like material, and when the positions of the target portion in the images of the sheet-like material focused on the respective image pickup devices are displaced from the first reference position and the second reference position in the same direction by the same amount, the measuring means determines that the pass line fluctuation is not generated, and measures a horizontal position deviation of the target portion of the sheet-like material.

According to a third aspect of the present invention, in the position measuring system according to the first or second aspect, for example, when the positions of the target portion in the images of the sheet-like material focused on the respective image pickup devices are displaced from the first reference position and the second reference position in opposed directions, the measuring means determines that the pass line fluctuation is generated, and measures a vertical position deviation of the target portion of the sheet-like material.

According to a fourth aspect of the present invention, in the position measuring system according to any one of the first to third aspects, for example, the storage means stores a data table storing, in a correlated manner, amounts, types and directions of position deviations of the target portion of the sheet-like material, of which image is previously taken by the first camera means and the second camera means, from the first reference position and the second reference position, and the measuring means measures an amount, a type and a direction of the position deviation of the target portion of the sheet-like material based on directions and displacement amounts of the position deviations of the target portion of the sheet-like material on the respective image pickup devices of the first and second camera means, as well as on the data table.

According to a fifth aspect of the present invention, in the position measuring system according to any one of the first to fourth aspects, for example, the sheet-like material is arranged in two or more rows in a direction crossing a lengthwise direction of the sheet-like material, the first camera means is installed substantially above an outer peripheral end of one of the arranged sheet-like materials, includes an image pickup device to receive a focused image of the one sheet-like material, and takes an image of a preset target portion of the one sheet-like material, and the second camera means is installed substantially above an outer peripheral end of another one sheet-like material, includes an image pickup device to receive a focused image of the other one sheet-like material, and takes an image of a preset target portion of the other one sheet-like material.

According to a sixth aspect of the present invention, in the position measuring system according to any one of the first to fifth aspects, for example, the sheet-like material and the image pickup devices are installed parallel to each other, and the position measuring system further comprises lens shift means for translating a lens disposed between the sheet-like material and each of the image pickup devices such that the image of the sheet-like material is focused on the relevant image pickup device.

According to the exemplary embodiment, since the position measuring system comprises the first camera means installed substantially above one edge of the sheet-like material, including the image pickup device to receive the focused image of the sheet-like material, and taking the image of the target portion of the sheet-like material, the second camera means installed substantially above the other edge of the sheet-like material, including the image pickup device to receive the focused image of the sheet-like material, and taking the image of the target portion of the sheet-like material, and the measuring means for, based on variations of the positions of the target portion from the preset reference positions in the images of the sheet-like material focused on the respective image pickup devices, determining the occurrence of the pass line fluctuation and measuring the position deviation of the target portion (e.g., the edge), the position measuring system can accurately measure the position of the target portion (e.g., the edge) without being affected by the coating pattern that is changed depending on the product type (namely, without needing the set-up operation for each of different product types).

Also, because of requiring only two sets of the cameras and lenses combined with each other, the position measuring system is advantageous in that the system can be realized with an installing operation in a shorter time and with a lower cost.

Further, the position measuring system can measure the direction (deviation direction) and the displacement amount (movement or deviation amount) of the vertical position deviation of the target portion (e.g., the edge (coating end)) due to the pass line fluctuation, and the direction (deviation direction) and the displacement amount (movement or deviation amount) of the horizontal position deviation thereof independently of each other by the measuring means that extracts the direction and the displacement amount of the vertical position deviation due to the pass line fluctuation and the direction and the displacement amount of the horizontal position deviation, based on the direction and the displacement amount of the position deviation of the target portion (e.g., the edge) of the battery electrode sheet in the images taken by the respective image pickup devices of the cameras, from the data table stored in the storage means whenever the image of the battery electrode sheet is taken. As a result, the position measuring system is advantageous in separately calculating the “horizontal position deviation” of the target portion (e.g., the edge (coating end)) and the “vertical position deviation” thereof due to the pass line fluctuation, which deviations occur in a complex way.

### BRIEF DESCRIPTION OF THE DRAWINGS

FIG. 1 illustrates one example of configuration of a position measuring system according to the present invention;

FIGS. 2A to 2C are illustrations to explain the operation of a measurement means in FIG. 1; and

FIG. 3 illustrates one example of configuration of a known position measuring system.

### DESCRIPTION OF THE PREFERRED EMBODIMENTS

### Outline of Configuration

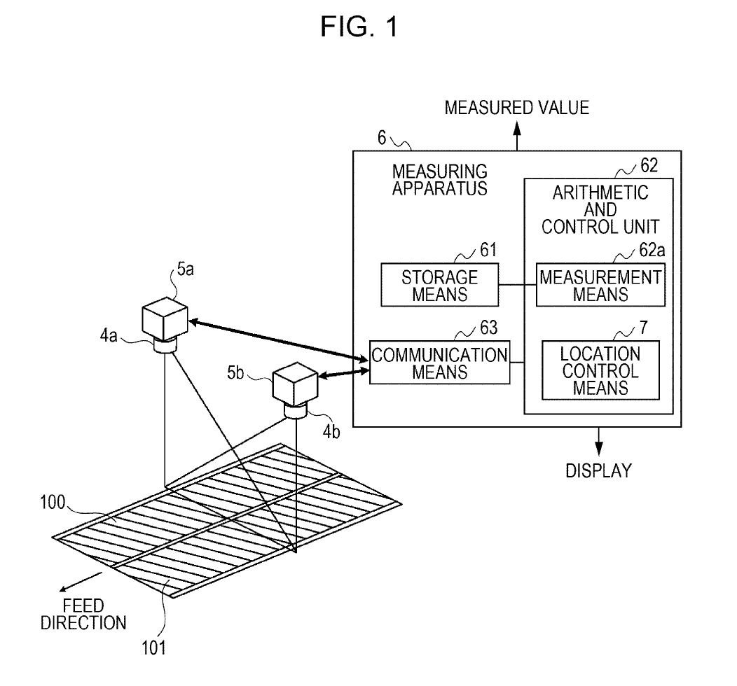

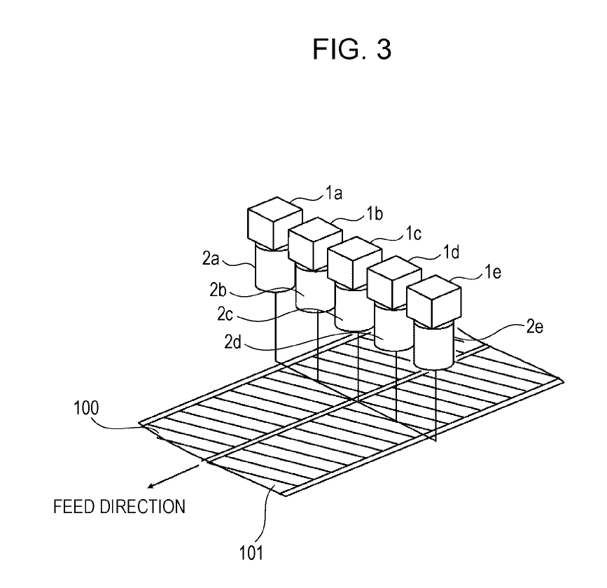

FIG. 1 illustrates one example of configuration of a position measuring system according to the present invention. In FIG. 1, components common to those in FIG. 3 are denoted by the same symbols.

The position measuring system of FIG. 1 differs from the system of FIG. 3 in that, in FIG. 1, a first camera means and a second camera means are installed respectively substantially above (upward perpendicularly to the feed direction) an edge (outer peripheral end) of one of sheet-like materials, which are arranged in two rows in a direction crossing the lengthwise direction of the sheet-like materials, and substantially above an edge (outer peripheral end) of the other sheet-like material.

Another difference between FIG. 1 and FIG. 3 is in including measuring means, which determines the occurrence of a pass line fluctuation based on variations of the positions of a target portion (e.g., an edge) from preset reference positions in respective images of the sheet-like material focused on image pickup devices that are included in the first and second camera means (cameras), and which measure a position deviation of the target portion (e.g., the edge).

Referring to FIG. 1, the position measuring system primarily includes feed rollers (not shown) for supporting and conveying battery electrode sheets 100 and 101, which are one example of the sheet-like material and which are arranged side by side in a direction crossing the feed direction thereof, in such a state that a pass line of the conveyed sheets is held almost constant, a camera 5a which is one example of first camera means and which takes respective images of preset target portions (e.g., edges (outer peripheral ends)) of the battery electrode sheets 100 and 101 through a lens 4a, a camera 5b which is one example of second camera means and which takes respective images of the preset target portions (e.g., the edges (outer peripheral ends)) of the battery electrode sheets 100 and 101 through a lens 4b, and a measuring apparatus 6, which is electrically connected to the cameras 5a and 5b through connecting lines, which determines the occurrence of a pass line fluctuation based on variations of the positions of the target portions (e.g., the edges) from preset “reference positions” in respective images of the battery electrode sheets 100 and 101 focused on image pickup devices that are included in the cameras 5a and 5b, and which measures position deviations of the target portions (e.g., the edges) of the sheets.

Here, the term “position deviation” includes a “horizontal position deviation” that is a deviation on a sheet plane in a direction (hereinafter referred to as a “horizontal direction”) perpendicular to the sheet feed direction, and a “vertical position deviation” that is a deviation caused in the vertical (height) direction due to the pass line fluctuation.

The position measuring system may further include a location control means 7 for transmitting, to a driving means (not shown), control data used in position control to compensate for the position deviation and controlling the relevant sheet to be located in a correct position, and a lens shift means (not shown) for translating (parallel-moving) the lenses 4a and 4b, which are installed respectively between the battery electrode sheets 100, 101 and the cameras 5a, 5b, such that the images of the sheet-like materials are focused on the image pickup devices included in the cameras 5a and 5b.

### (Explanation of Main Components)

The battery electrode sheets 100 and 101 as one example of the sheet-like material are conveyed in such a state that the sheets are supported by the feed rollers (not shown) and a pass line of the conveyed sheets is held almost constant.

Those two rows of battery electrode sheets are successively arranged side by side in a direction crossing (perpendicular) to the lengthwise direction of the sheets (i.e., to the sheet feed direction).

The lenses 4a and 4b are substantially the same one and are attached to the cameras 5a and 5b, respectively. The lenses 4a and 4b are each, for example, a lens having an ordinary angle of view. In particular, the lenses 4a and 4b are each preferably a lens having such a low level of strain (distortion) as not adversely affecting the measurement.

In general, the lenses 4a and 4b are each constituted by a low-strain shooting lens, which is represented by an enlarging lens with small distortion, and which is optically designed to be substantially symmetrical with respect to a diaphragm. This is because the enlarging lens has a merit in that it has a left-right symmetric lens structure with respect to the diaphragm on the basis of the Gauss optical system and it does not generate distortion due to the specific lens structure.

The cameras 5a and 5b are each a line camera or an area camera. The cameras 5a and 5b are combined with the lenses 4a and 4b, respectively, and are installed substantially above (substantially right above) outer peripheral ends (coating ends) of the battery electrode sheets 100 and 101 that are successively arranged side by side. At that time, the cameras 5a and 5b are installed such that a straight line interconnecting the cameras 5a and 5b lies in a direction substantially perpendicular to the lengthwise direction of the battery electrode sheets 100 and 101.

Further, the cameras 5a and 5b are installed while the focal lengths and the shooting distances of the lenses 4a and 4b are set to provide magnifications at which each camera can take the images of the battery electrode sheets 100 and 101 over the entire width thereof.

In more detail, the camera 5a is combined with the lens 4a and is installed substantially above (upward perpendicularly to the feed direction (substantially right above)) the outer peripheral end of one of the battery electrode sheets 100 and 101 (i.e., the edge of the battery electrode sheet 100 on the side not adjacent to the battery electrode sheet 101).

The camera 5b is combined with the lens 4b and is installed substantially above (upward perpendicularly to the feed direction (substantially right above)) the outer peripheral end of the other of the battery electrode sheets 100 and 101 (i.e., the edge of the battery electrode sheet 101 on the side not adjacent to the battery electrode sheet 100).

The cameras 5a and 5b are installed such that their postures, magnifications, distortions in image-taking, e.g., trapezoidal distortions, etc. are exactly matched with each other so as to make the camera 5a and the camera 5b have the same field of view. For example, the camera 5a takes the images of the target portions (e.g., the edges) of the battery electrode sheets 100 and 101.

On that occasion, the battery electrode sheets 100 and 101 and the image pickup devices in the cameras 5a and 5b are positioned parallel to each other.

For example, the camera 5a (or the camera 5b) takes the image of the target portion (e.g., the edge) of the battery electrode sheet 100 and the image of the target portion (e.g., the edge) of the battery electrode sheet 101 in such a state that the lens shift means (not shown) translates only the lens 4a (or the lens 4b) relative to the image pickup device in the relevant camera while holding the image pickup device parallel to the battery electrode sheets 100 and 101.

Therefore, an image circle of the lens or the image pickup device can be effectively utilized, and a level of the specification required for the camera lens can be reduced in practical design of the camera.

In other words, the posture of the camera 5a (or the camera 5b) is not inclined to take the image of the target portion (e.g., the edge (coating end)) of the battery electrode sheet 100 (or the battery electrode sheet 101) that is arranged on the side opposite to the relevant camera. It is to be noted that, as per necessity, the posture of the camera may be inclined to take the image of the target portion (e.g., the edge (coating end)) of the battery electrode sheet 100 (or the battery electrode sheet 101) that is arranged on the side opposite to the relevant camera.

The measuring apparatus 6 primarily includes a storage means 61 for previously storing a “first reference position” and a “second reference position”, which serve as references to measure the position deviations based on the images taken by the cameras 5a and 5b, an arithmetic and control unit 62 such as a CPU (Central Processing Unit), a measurement means 62a controlled by the arithmetic and control unit 62, determining the presence or absence of a pass line fluctuation, and measuring the position deviations, and a communication means 63 for communicating data with respect to the cameras 5a and 5b or an external device.

The arithmetic and control unit 62 specifies, based on the image data received from the cameras 5a and 5b through the communication means 63, the positions of the target portions (e.g., the edges) of the battery electrode sheets 100 and 101, of which images are taken by the image pickup devices, with respect to the positions of preset origins, for example, in terms of two-dimensional data such as coordinate values, and then stores the specified positions in the storage means 61.

Here, the arithmetic and control unit 62 primarily controls the measurement means 62a and other various functions in an integrated manner. In more detail, the arithmetic and control unit 62 may boot up, e.g., an OS stored in the storage means 61 and may read and execute stored programs in accordance with the OS, thereby controlling the entire position measuring system, including the measuring apparatus 6, such that the measuring apparatus 6 performs operations specific to it. For example, a RAM (not shown) in a storage unit is used as a working area when the measuring apparatus 6 performs the operations.

The storage means 61 in the measuring apparatus 6 is constituted as, e.g., a ROM (Read Only Memory), a RAM (Random Access Memory), a flash memory, or a hard disk, and it primarily stores the OS, programs for causing the measuring apparatus 6 to operate as a controller, and various kinds of information including the first reference position, the second reference position, a data table for use in the measurement of the position deviations, etc.

The first reference position is provided, for example, as one or more sets of two-dimensional coordinate data (e.g., one or more sets of coordinate values of the images taken by the image pickup device of the camera 5a) representing the positions of the target portions (e.g., the edges) of the battery electrode sheets 100 and 101, of which images are previously taken by the camera 5a to measure the position deviations of the target portions (e.g., the edges).

The second reference position is provided, for example, as one or more sets of two-dimensional coordinate data (e.g., one or more sets of coordinate values of the images taken by the image pickup device of the camera 5b) representing the positions of the target portions (e.g., the edges) of the battery electrode sheets 100 and 101, of which images are previously taken by the camera 5b to measure the position deviations of the target portions (e.g., the edges).

Further, the storage means 61 previously stores a table for use in the measurement of the position deviations (hereinafter referred to simply as a “data table”), the table including coordinate data per pixel, which indicate how the target portions (e.g., the edges) of the battery electrode sheets 100 and 101 appear to the cameras 5a and 5b depending on the amounts and the directions of movements of the sheets.

By comparing the coordinate data stored in the data table with the coordinate data of the target portions (e.g., the edges) in the taken images, the position measuring system can separately determine and output the position deviation of, e.g., the coating end and the pass line fluctuation, which deviations occur in a complex way.

In more detail, the data table is prepared by previously taking the images of the battery electrode sheets 100 and 101 in plural patterns under various shooting conditions, including different pass line fluctuations, with the cameras 5a and 5b, and by correlating, based on the taken images, the two-dimensional data for each of the target portions (e.g., the edges) of the battery electrode sheets 100 and 101, of which images are taken by the cameras, (e.g., the coordinate values of the images taken by (all) the image pickup devices) in the form of a table by employing the arithmetic and control unit 62.

The data table can be obtained, for example, through the following operations.

Previously, a dedicated chart is prepared by using a material that is stable in dimensional accuracy (namely, that is not expanded or contracted depending on temperature etc.), and an image of the chart is taken by the cameras 5a and 5b. As another example, an image of graduations of a scale is previously taken by the cameras 5a and 5b.

The pass line fluctuation (i.e., the position deviation in the height direction, also called the vertical position deviation) is artificially generated by using a bed on which the battery electrode sheets are placed or camera stands, the bed and the camera stands being able to optionally change their positions in the height direction, and the images of the battery electrode sheets are taken by the cameras 5a and 5b nine times while the height (vertical position) of the battery electrode sheets is changed from the preset position over a range of −4 to +4 mm in units of 1 mm.

Further, the position deviation in the horizontal direction (also called the horizontal position deviation) is artificially generated by using a bed on which the battery electrode sheets are placed or camera stands, the bed and the camera stands being able to optionally change their positions in the horizontal direction, and the images of the battery electrode sheets are taken by the cameras 5a and 5b nine times while the horizontal (left-and-right) positions of the battery electrode sheets are changed from the preset position over a range of −4 to +4 mm in units of 1 mm.

Moreover, the position deviation in the height direction (i.e., the pass line fluctuation) and the position deviation in the horizontal direction are artificially generated by using a bed on which the battery electrode sheets are placed or camera stands, the bed and the camera stands being able to optionally change their positions in both the height direction and the horizontal direction, and the images of the battery electrode sheets are taken by the cameras 5a and 5b nine times while the horizontal (left-and-right) and vertical positions of the battery electrode sheets are changed from the preset position over a range of −4 to +4 mm in units of 1 mm in the horizontal direction and the height direction.

The arithmetic and control unit 62 detects the positions of the target portions (e.g., the edges) of the battery electrode sheets 100 and 101 based on a two-dimensional coordinate system having an origin defined as the preset position. Then, the arithmetic and control unit 62 prepares a data table by correlating the coordinate values of the positions of the target portions (e.g., the edges), which have been obtained by the cameras 5a and 5b, with respective amounts of the position deviations in the horizontal and height directions, which have been artificially generated, and stores the prepared data table in the storage means 61.

Alternatively, when it is determined from the images taken in plural patterns as described above that the two-dimensional coordinate position of any target portion (edge) in the image taken by the camera 5a is deviated (displaced) from the first reference position, the arithmetic and control unit 62 may store the “amount of the displacement” and the “direction of the position deviation” in a data table in correlation with the respective amounts of the position deviations in the horizontal and height directions, which have been artificially generated.

Further, when it is determined from the images taken in plural patterns as described above that the two-dimensional coordinate position of any target portion (edge) in the image taken by the camera 5b is deviated (displaced) from the second reference position, the arithmetic and control unit 62 may store the “amount of the displacement” and the “direction of the position deviation” in a data table in correlation with the respective amounts of the position deviations in the horizontal and height directions, which have been artificially generated.

Thus, the position measuring system stores the data table in the storage means 61 based on the measured position data of the target portions (e.g., the edges).

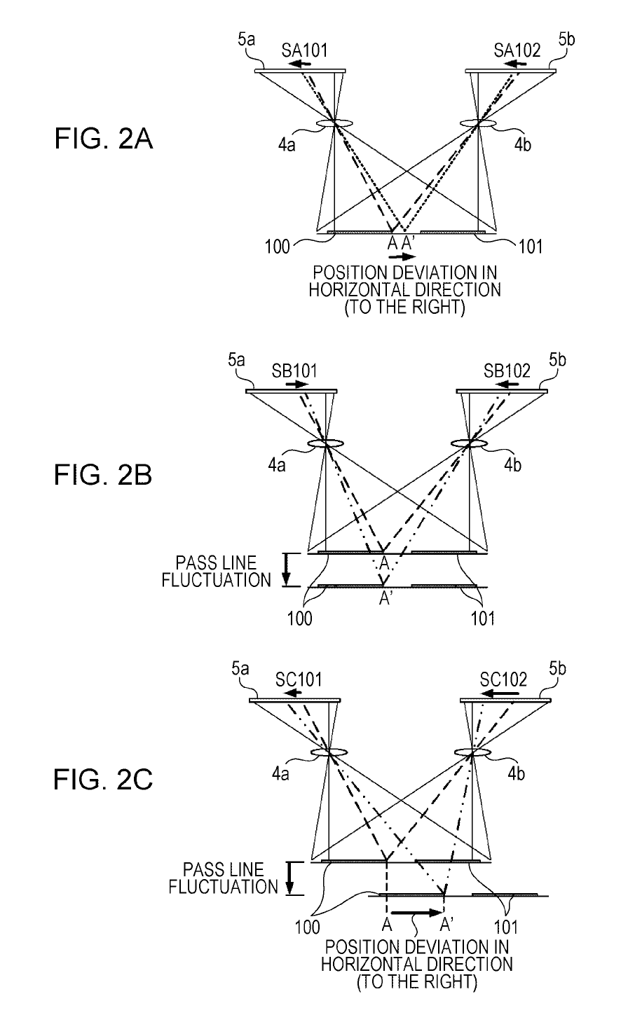

The measurement means 62a calculates the “amounts of the displacements” and the “directions of the position deviations” from the reference positions set for the image pickup devices of the cameras 5a and 5b based on not only the first reference value, the second reference value, and the data table, which are stored in the storage means 61, but also the coordinate values of the positions of the target portions (e.g., the edges) of the battery electrode sheets 100 and 101, which appear as images on the image pickup devices. Further, the measurement means 62a compares the calculated “amounts of the displacements” and “directions of the position deviations” to determine whether the calculated information includes a factor attributable to the pass line fluctuation (i.e., determines the occurrence of the pass line fluctuation), and measures the position deviations of the edges. The detailed operation will be described later with reference to FIG. 2.

### (Explanation of Operation)

The position measuring system having the above-described configuration operates as follows.

(1) The feed rollers convey the battery electrode sheets 100 and 101.

(2) The cameras 5a and 5b take the images of the preset target portions (e.g., the edges (outer peripheral ends)) of the conveyed battery electrode sheets 100 and 101 through the lenses 4a and 4b, respectively, and transmit data of the taken images to the measuring apparatus 6.

(3) The measurement means 62a in the measuring apparatus 6 calculates the “amounts of the displacements” and the “directions of the position deviations” from the reference positions set for the image pickup devices of the cameras 5a and 5b, compares the calculated “amounts of the displacements” and “directions of the position deviations” to determine whether the calculated information includes the factor attributable to the pass line fluctuation (i.e., to determine the occurrence of the pass line fluctuation), and measures the position deviations of the target portions (e.g., the edges). In more detail, the measurement means 62a performs at least one of the following operations (3-1), (3-2) and (3-3).

(3-1) When the positions of the target portions in the images of the battery electrode sheets 100 and 101, which are focused on the respective image pickup devices, are moved from the first reference position and the second reference position in the “same direction” by the “same amount”, the measurement means 62a determines that only the horizontal position deviation is generated and the pass line fluctuation is not generated, and measures the position deviations (i.e., the deviation directions and the displacement amounts) of the target portions (e.g., edges) of the battery electrode sheets 100 and 101.

(3-2) When the positions of the target portions in the images of the battery electrode sheets 100 and 101, which are focused on the respective image pickup devices, are moved from the first reference position and the second reference position in the “opposed directions” by the “same amount”, the measurement means 62a determines that only the vertical position deviation due to the pass line fluctuation is generated, and measures the position deviations (i.e., the deviation directions and the displacement amounts) of the target portions (e.g., edges) of the battery electrode sheets 100 and 101.

(3-3) When the positions of the target portions in the images of the battery electrode sheets 100 and 101, which are focused on the respective image pickup devices, are moved from the first reference position and the second reference position in the “opposed directions” through “different amounts”, the measurement means 62a determines that the horizontal position deviation and the vertical position deviation due to the pass line fluctuation are both generated, and measures the position deviations (i.e., the deviation directions and the displacement amounts) of the target portions (e.g., edges) of the battery electrode sheets 100 and 101.

Further, based on not only the positions of an edge A (FIGS. 2A to 2C) in the images taken by the cameras 5a and 5b (or the directions and the displacement amounts of the position deviation of the edge A from the respective reference positions in those images), but also the data table stored in the storage means 63, the measurement means 62a calculates the amount by which the horizontal position deviation is generated in which one of the leftward and rightward directions, or the amount by which the pass line is moved in which one of the upward and downward directions.

(4) The arithmetic and control unit 62 in the measuring apparatus 6 transmits, to the driving means (not shown), control data for position control to compensate for the position deviations (i.e., the direction and the displacement amount of the position deviation due to the pass line fluctuation, and the direction and the displacement amount of the horizontal position deviation), which have been measured by the measurement means 62a.

For example, when the measurement means 62a determines that only the horizontal position deviation is generated and the sheet end is displaced to the right from the normal position in the horizontal direction, the arithmetic and control unit 62 transmits the control data to the driving means such that the battery electrode sheets are moved to the left.

(5) The driving means moves the positions of the battery electrode sheets 100 and 101 in accordance with the received control data. For example, the driving means moves the sheets to the left in accordance with the control data.

### (Detailed Explanation of Operation of Measurement Means)

The operation of the measurement means 62a for measuring the position deviations will be described in more detail below with reference to FIGS. 2A to 2C. FIGS. 2A to 2C are illustrations to explain the operation of the measurement means 62a in FIG. 1. More specifically, FIG. 2A is an illustration to explain the case where only the “horizontal position deviation” is generated and the pass line fluctuation is not generated, FIG. 2B is an illustration to explain the case where only the “vertical position deviation” is generated (only the pass line fluctuation is generated), and FIG. 2C is an illustration to explain the case where the “vertical position deviation” and the “horizontal position deviation” are both generated.

It is to be noted that while, in FIGS. 2A to 2C, areas around the image pickup devices are drawn in an exaggerated way for the purpose of easier understanding, the actual position measuring system may be constructed at a general shooting magnification instead of the scale in the drawings.

Referring to FIGS. 2A to 2C, the camera 5a takes the image of the edge (coating end) A of the battery electrode sheet 100 through the lens 4a, and the camera 5b also takes the image of the same edge A.

Variations of the position of the edge A, in particular, from the reference position are described below. Since variations of the positions of the other edges and the target portions from the reference positions are similar to the case of the edge A, description of those variations is omitted.

Suppose now that, as illustrated in FIG. 2A, the “horizontal position deviation” is generated and the edge A is moved to the “right” as viewed on the drawing.

In that case, the image of the edge A of the battery electrode sheet 100, which appears on the image pickup device of the camera 5a, is moved to the “left” from the first reference position on the image pickup device (as indicated by an arrow SA101).

Since the camera 5b has the same shooting magnification as the camera 5a, the image of the edge A of the battery electrode sheet 100, which appears on the image pickup device of the camera 5b, is also moved to the “left” from the second reference position by the same amount on the image pickup device (as indicated by an arrow SA102).

Thus, when only the horizontal position deviation is generated, the positions of the battery electrode sheet appearing on the image pickup devices of the cameras 5a and 5b are moved in the same direction from the respective reference positions.

Stated another way, because the pass line fluctuation is not generated and only the “horizontal position deviation” is generated while the distances between the lenses 4a, 4b and the image pickup devices of the cameras 5a and 5b are held fixed, the images appearing on the image pickup devices of the cameras 5a and 5b are moved in the same direction.

As described above, when the images of the positions of the edge A, which are focused on the respective image pickup devices, are moved from the first reference position and the second reference position in the “same direction” by the “(almost) same amount”, the measurement means 62a determines that only the “horizontal position deviation” is generated and the pass line fluctuation is not generated, and measures the position deviation of the edge A of the battery electrode sheet 100.

In other words, when the images of the target edge A are moved in the same direction by the same amount on both the image pickup devices of the cameras 5a and 5b, the measurement means 62a determines that the pass line fluctuation is not generated. Hence, the amount by which the image of the target edge A is moved can be used, as it is, in calculating the displacement amount of the edge (i.e., the distance of the position deviation).

Thus, according to the position measuring system, when, as in the case of FIG. 2A, the measurement means measures, based on the deviations of the positions of the target portions from the preset reference positions in the images of the battery electrode sheets taken by the cameras, that the images of the target portions taken by the cameras are moved in the “same direction” by the “same amount”, it determines that the pass line fluctuation is not generated. Therefore, the measurement means can measure the “deviation direction” and the “displacement amount” of the horizontal position deviation of the target portion while eliminating the influence of the pass line fluctuation.

Herein, the pass line fluctuation is irrelevant to the product accuracy.

According to the position measuring system, therefore, when the images of the target portions taken by the cameras are moved in the “same direction” by the “same amount”, the position of the edge (coating end) in the horizontal direction, i.e., the horizontal position deviation thereof, can be accurately measured by eliminating the influence of the pass line fluctuation. This is advantageous in that the location control means 7 can feedback the measured result to a coater (coating machine) and can perform the coating operation at a constant position.

Suppose now that, as illustrated in FIG. 2B, the pass line fluctuation is generated (e.g., the pass line is moved downward) and the “vertical position deviation” is generated.

In that case, because the pass line is moved downward, the image of the battery electrode sheet 100, which appears on the image pickup device of the camera 5a, is scaled down in its entirety and the image of the edge A is moved to the “right” from the first reference position on the image pickup device (as indicated by an arrow SB101).

On the other hand, the image of the edge A of the battery electrode sheet 100, which appears on the image pickup device of the camera 5b, is moved to the “left” from the second reference position by the same amount on the image pickup device (as indicated by an arrow SB102).

Thus, when only the pass line fluctuation is generated, the positions of the battery electrode sheet appearing on the image pickup devices of the cameras 5a and 5b are moved in the opposed directions from the respective reference positions.

Because only the pass line is moved downward (without any position deviation in the horizontal direction) while the distances between the lenses 4a, 4b and the image pickup devices of the cameras 5a and 5b are held fixed, the distances between the lenses 4a, 4b and the battery electrode sheets 100, 101 are increased, and hence the images appearing on the image pickup devices of the cameras 5a and 5b are moved in the opposed directions.

As described above, when the positions of the target portion in the images of the battery electrode sheets 100 and 101, which are focused on the respective image pickup devices, are moved from the first reference position and the second reference position in the “opposed directions” by the “(almost) same amount”, the measurement means 62a determines that only the pass line fluctuation is generated, and measures the position deviation of the edge A of the battery electrode sheet 100.

In other words, when the images of the target edge A are moved in the opposed directions by the same amount on the image pickup devices of the cameras 5a and 5b, the measurement means 62a determines that only the pass line fluctuation is generated. Hence, the amount by which the image of the target edge A is moved can be used, as it is, in calculating the displacement amount of the edge (i.e., the distance of the position deviation).

Thus, according to the position measuring system, when, as in the case of FIG. 2B, the measurement means measures, based on the deviations of the positions of the target portions from the preset reference positions in the images of the battery electrode sheets taken by the cameras, that the images of the target portions taken by the cameras are moved in the “opposed directions” by the “same amount”, it determines that only the pass line fluctuation is generated. Therefore, the measurement means can measure the “deviation direction” and the “displacement amount” of the vertical position deviation of the target portion.

Suppose now that, as illustrated in FIG. 2C, the “horizontal position deviation” and the “vertical position deviation” are both generated, whereby the edge A is moved to the “right” as viewed on the drawing and the position of each battery electrode sheet is moved downward due to the pass line fluctuation.

Actually, a complex position deviation including both of the pass line fluctuation (i.e., the vertical position deviation) and the horizontal position deviation, as illustrated in FIG. 2C, is generated in many cases.

Even in that case, as described below, the position measuring system can separately output the horizontal position deviation and the vertical position deviation of the target portion (e.g., the edge (coating end)), which occur in a complex way, by comparing the positions of the target portions in the images of the battery electrode sheets 100 and 101, which are focused on the image pickup devices of the cameras 5a and 5b, based on the data table stored in the storage means 63.

In more detail, the image of the battery electrode sheet 100, which appears on the image pickup device of the camera 5a, is scaled down in its entirety and the image of the edge A is moved to the “left” by a displacement amount of, e.g., 0.5 mm from the first reference position on the image pickup device (as indicated by an arrow SC101).

Since the camera 5b has the same shooting magnification as the camera 5a, the image of the edge A of the battery electrode sheet 100, which appears on the image pickup device of the camera 5b, is moved to the “left (in the same direction)” by a displacement amount of, e.g., 1.0 mm from the second reference position on the image pickup device (as indicated by an arrow SC102).

When the positions of the target portion in the images of the battery electrode sheet 100, which are focused on the image pickup devices of the cameras 5a and 5b, are moved from the first reference position and the second reference position in the “same direction” by “different amounts”, the measurement means 62a determines that the pass line fluctuation and the horizontal position deviation are both generated, and measures the position deviation of the edge A.

Further, based on not only the directions and the displacement amounts of the position deviation of the edge A in the respective images taken by the cameras 5a and 5b, but also the data table stored in the storage means 63, the measurement means 62a calculates the amount by which the horizontal position deviation is generated in which one of the leftward and rightward directions, or the amount by which the pass line is moved in which one of the upward and downward directions.

For example, based on not only information representing that the image of the edge A appearing on the image pickup device of the camera 5a is moved to the “left” by 1 mm and the image of the edge A appearing on the image pickup device of the camera 5b is moved to the “left” by 0.5 mm, but also the data table stored in the storage means 63, the measurement means 62a extracts the corresponding type, direction, and displacement amount of the position deviation from the data table (or it may estimate them from the tendency of data included in the data table through calculation).

Based on the data table, the measurement means 62a extracts (or calculates) the position deviation of the battery electrode sheet 100, for example, such that the vertical position deviation is generated by 5 mm in the “downward” direction due to the pass line fluctuation, and the horizontal position deviation is generated by 1 mm to the “right”.

Depending on the amounts of the “horizontal position deviation” and the “vertical position deviation”, the directions and the displacement amounts of the position deviation of the edge A appearing on the image pickup devices of the cameras 5a and 5b may differ from those illustrated in FIG. 2C.

In some case, for example, the image of the edge A may be moved to the “left” by the displacement amount of 0.5 mm on the image pickup device of the camera 5a, while it may be moved to the “right” (i.e., in the direction opposed to that on the image pickup device of the camera 5a) by the displacement amount of 1 mm on the image pickup device of the camera 5b.

Hence, even in the case of FIG. 2C, the position measuring system can determine that the generated “deviation” is which one of the horizontal position deviation, the vertical position deviation, and the complex deviation including both the horizontal position deviation and the vertical position deviation, by the measuring apparatus 6 that extracts or calculates, based on position variations (i.e., the direction deviations and the displacement amounts) of the target portion (e.g., the edge) of each of the battery electrode sheets 100 and 101 from the respective reference positions in the images taken by the respective image pickup devices of the cameras 5a and 5b, the direction and the displacement amount of the vertical position deviation due to the pass line fluctuation and the direction and the displacement amount of the horizontal position deviation from the data table stored in the storage means 63 whenever the images of the battery electrode sheets are taken.

Further, the position measuring system can measure the direction and the displacement amount (movement or deviation amount) of the “vertical position deviation” of the target portion (e.g., the edge (coating end)) due to the pass line fluctuation, and the direction and the displacement amount (movement or deviation amount) of the “horizontal position deviation” thereof independently of each other.

Stated another way, the position measuring system can separately calculate the “horizontal position deviation” of the target portion (e.g., the edge (coating end)) and the “vertical position deviation” thereof due to the pass line fluctuation, which deviations occur in a complex way.

Thus, since the position measuring system comprises first camera means installed substantially above one edge of a sheet-like material, including an image pickup device to receive a focused image of the sheet-like material, and taking an image of a target portion of the sheet-like material, second camera means installed substantially above the other edge of the sheet-like material, including an image pickup device to receive a focused image of the sheet-like material, and taking an image of the target portion of the sheet-like material, and measuring means for, based on variations of positions of the target portion from preset reference positions in the images of the sheet-like material focused on the respective image pickup devices, determining occurrence of a pass line fluctuation, and measuring a position deviation of the target portion (e.g., the edge), the position measuring system can accurately measure the position of the target portion (e.g., the edge) without being affected by the coating pattern that is changed depending on the product type (namely, without needing the set-up operation for each of different product types).

Also, because of requiring only two sets of the cameras and the lenses combined with each other, the position measuring system is advantageous in that the system can be realized with an installing operation in a shorter time and with a lower cost.

Further, the position measuring system can measure the direction and the displacement amount (movement or deviation amount) of the vertical position deviation of the target portion (e.g., the edge (coating end)) due to the pass line fluctuation, and the direction and the displacement amount (movement or deviation amount) of the horizontal position deviation thereof independently of each other by the measuring apparatus 6 that extracts, based on the direction and the displacement amount of the position deviation of the target portion (e.g., the edge) of each of the battery electrode sheets 100 and 101 in the images on the respective image pickup devices of the cameras, the direction and the displacement amount of the vertical position deviation due to the pass line fluctuation and the direction and the displacement amount of the horizontal position deviation from the data table stored in the storage means 63 whenever the images of the battery electrode sheets are taken. In other words, the position measuring system is advantageous in that the position deviation of the target portion (e.g., the edge (coating end)) can be measured without being affected by the pass line fluctuation.

In addition, the pass line fluctuation is irrelevant to the product accuracy. More specifically, the pass line fluctuation may be not taken into consideration when the measurement can be performed off-line as in a sampling inspection. In the case of an in-line apparatus, however, because production is continuously performed, it is required to adjust the in-line apparatus through feedback control at all times (or it is required, instead of making the feedback control at all times, to take an action to adjust the in-line apparatus if the position deviation exceeds a preset limit value).

Since the position measuring system can accurately measure the directions and the displacement amounts (movement or deviation amounts) of both the vertical position deviation and the horizontal position deviation of the target portion (e.g., the edge (coating end)) independently of each other, it is advantageous in enabling the coater to perform the coating operation at a constant position through the feedback control by the location control means 7.

Stated another way, the position measuring system is advantageous in that, since the position of the edge (coating end) can be always held constant (within the demanded accuracy) in a production line, the accuracy of operation in an assembly step, which is subsequent to the coating step, can be increased. In addition, the position measuring system is advantageous in contributing to an improvement of product quality.

### Other Embodiments

While the foregoing embodiment has been described in connection with the measurement of the position deviation for two rows of sheets, the present invention is not particularly limited to the illustrated embodiment and is further applicable to the measurement of the position deviation for one row of sheet.

In the latter case, the position measuring system can also accurately measure the position deviation of the target portion (e.g., the edge) of the sheet without being affected by the coating pattern that is changed depending on the product type (namely, without needing the set-up operation for each of different product types). Moreover, because of requiring only two sets of the cameras and the lenses combined with each other, the position measuring system is advantageous in that the system can be realized with an installing operation in a shorter time and with a lower cost.

While the foregoing embodiment has been described in connection with the measurement of the position deviation for two rows of sheets, the present invention is not particularly limited to the illustrated embodiment and is further applicable to the measurement of the position deviation for each of three or more rows of sheets that are arranged side by side in a direction crossing the feed direction.

In the latter case, the position measuring system can also accurately measure the position deviation of the target portion (e.g., the edge) of each sheet without being affected by the coating pattern that is changed depending on the product type (namely, without needing the set-up operation for each of different product types). Moreover, because of requiring only two sets of the cameras and the lenses combined with each other, the position measuring system is advantageous in that the system can be realized with an installing operation in a shorter time and with a lower cost.

While the foregoing embodiment has been described as using the battery electrode sheet as one example of the sheet-like material, the present invention is not particularly limited to the illustrated embodiment, and the sheet-like material may be any of suitable continuous materials, such as a sheet of paper, a film sheet, a metal film, a metal vapor-deposited film, a multilayer film sheet (e.g., a food wrapper), and a battery electrode.

A set of two cameras may be arranged plural to measure a wide sheet-like material. Further, the cameras may be positioned close to the sheet-like material to take an image of the sheet-like material at a high magnification so that photographing (image pickup) with high resolution of several microns is enabled.

The position measuring system may be used to perform maintenance and diagnosis of a feed apparatus for conveying the battery electrode sheet based on the direction and the displacement amount of the vertical position deviation due to the pass line fluctuation, which are calculated by the measuring apparatus 6. Alternatively, the data obtained with the position measuring system may be utilized as data for maintenance of the production line.

While the foregoing embodiment has been described as preferably using a low-strain lens for the lenses 4a and 4b, the present invention is not particularly limited to the illustrated embodiment. Instead of using the low-strain lens, the measuring apparatus 6 may realize correction of high-order lens strain (aberration), which is specific to a lens used, with the aid of software by previously taking an image of a calibration chart and storing the taken image in the storage means 61.

### APPENDIX

In the position measuring system according to any one of the first to sixth aspects of the present invention, the target portion is the edge of the sheet-like material.

What is claimed is:

1. A position measuring system for measuring a position of a preset target portion of a conveyed sheet-like material with a camera, the position measuring system comprising:
first camera means installed substantially above one edge of the sheet-like material, including an image pickup device to receive a focused image of the sheet-like material, and taking an image of the target portion of the sheet-like material;
second camera means installed substantially above the other edge of the sheet-like material, including an image pickup device to receive a focused image of the sheet-like material, and taking an image of the target portion of the sheet-like material; and
measuring means for, based on variations of positions of the target portion from preset reference positions in the images of the sheet-like material focused on the respective image pickup devices, determining occurrence of a pass line fluctuation that displaces the sheet-like material in a vertical direction, and measuring a position deviation of the target portion.

2. The position measuring system according to claim 1, further comprising storage means for previously storing a first reference position and a second reference position as reference positions for the target portion of the sheet-like material,
wherein when the positions of the target portion in the images of the sheet-like material focused on the respective image pickup devices are displaced from the first reference position and the second reference position in the same direction by the same amount, the measuring means determines that the pass line fluctuation is not generated, and measures a horizontal position deviation of the target portion of the sheet-like material.

3. The position measuring system according to claim 2, wherein when the positions of the target portion in the images of the sheet-like material focused on the respective image pickup devices are displaced from the first reference position and the second reference position in opposed directions, the measuring means determines that the pass line fluctuation is generated, and measures a vertical position deviation of the target portion of the sheet-like material.

4. The position measuring system according to claim 1, wherein the storage means stores a data table storing, in a correlated manner, amounts, types and directions of position deviations of the target portion of the sheet-like material, of which image is previously taken by the first camera means and the second camera means, from the first reference position and the second reference position, and
the measuring means measures an amount, a type and a direction of the position deviation of the target portion of the sheet-like material based on directions and displacement amounts of the position deviations of the target portion of the sheet-like material on the respective image pickup devices of the first and second camera means, as well as on the data table.

5. The position measuring system according to claim 1, wherein the sheet-like material is arranged in two or more rows in a direction crossing a lengthwise direction of the sheet-like material,
the first camera means is installed substantially above an outer peripheral end of one of the arranged sheet-like materials, includes an image pickup device to receive a focused image of the one sheet-like material, and takes an image of a preset target portion of the one sheet-like material, and
the second camera means is installed substantially above an outer peripheral end of another one sheet-like material, includes an image pickup device to receive a focused image of the other one sheet-like material, and takes an image of a preset target portion of the other one sheet-like material.

6. The position measuring system according to claim 1, wherein the sheet-like material and the image pickup devices are installed parallel to each other, and
the position measuring system further comprises lens shift means for translating a lens disposed between the sheet-like material and each of the image pickup devices such that the image of the sheet-like material is focused on the relevant image pickup device.

7. The position measuring system according to claim 1, wherein the target portion is the edge of the sheet-like material.

8. The position measuring system according to claim 2 or 3, wherein the storage means stores a data table storing, in a correlated manner, amounts, types and directions of position deviations of the target portion of the sheet-like material, of which image is previously taken by the first camera means and the second camera means, from the first reference position and the second reference position, and
the measuring means measures an amount, a type and a direction of the position deviation of the target portion of the sheet-like material based on directions and displacement amounts of the position deviations of the target portion of the sheet-like material on the respective image pickup devices of the first and second camera means, as well as on the data table.

9. The position measuring system according to any one of claims 2 to 4, wherein the sheet-like material is arranged in two or more rows in a direction crossing a lengthwise direction of the sheet-like material,
the first camera means is installed substantially above an outer peripheral end of one of the arranged sheet-like materials, includes an image pickup device to receive a focused image of the one sheet-like material, and takes an image of a preset target portion of the one sheet-like material, and
the second camera means is installed substantially above an outer peripheral end of another one sheet-like material, includes an image pickup device to receive a focused image of the other one sheet-like material, and takes an image of a preset target portion of the other one sheet-like material.

10. The position measuring system according to any one of claims 2 to 5, wherein the sheet-like material and the image pickup devices are installed parallel to each other, and
the position measuring system further comprises lens shift means for translating a lens disposed between the sheet-like material and each of the image pickup devices such that the image of the sheet-like material is focused on the relevant image pickup device.

11. The position measuring system according to any one of claims 2 to 6, wherein the target portion is the edge of the sheet-like material.
